(19) United States
(12) Patent Application Publication
(10) Pub. No.: US 2007/0003096 A1
(43) Pub. Date: Jan. 4, 2007

(54) Microphone and headphone assembly for the ear

(76) Inventor: Daehwi Nam, Queens, NY (US)

Correspondence Address: Steven Horowitz;Attorney for Applicant/Inventor, Suite 700, 295 Madison Avenue, New York, NY, 10017, US

(21) Appl. No.: 11/172,496

(22) Filed: Jun. 29, 2005

(51) Int. Cl. H04R 25/00

(52) U.S. Cl. 381/382

(57) ABSTRACT

A microphone unit positioned in one ear and including a microphone, noise cancellation tube and ear tube, and a headphone unit positioned in the other ear, together with a neck attachment unit around the wearer's neck form an assembly for connecting to a communication device such as a cellular telephone while jogging or exercising. The microphone unit has a first movable joint for holding the first wire and the first noise cancellation tube and for controlling a length of slack of the first wire. The headphone unit includes an earphone cap, a second noise cancellation tube and a second movable joint for holding the second wire and second noise cancellation tube and for controlling a length of slack of the second wire. The neck attachment unit comprises a C-shaped holder that holds the first wire and the second wire and includes two swivel arms as grippers.

### FIELD OF THE INVENTION

The field of this invention is assemblies of units that include a microphone and a headphone for use with cellular telephones, and more particularly, such assemblies that allow for positioning of the microphone unit in the ear of a user.

### BACKGROUND OF THE INVENTION AND DISCUSSION OF THE PRIOR ART

With the popularity and ubiquity of cellular telephones, various versions of cellular telephone assemblies came into being whereby the user can speak on the cellular telephone without having to hold the telephone and speak into a microphone incorporated into the housing of the phone; rather the microphone is outside the phone and the telephone can be pocketed or held in a convenient location. For example, a jogger would prefer to not have to hold the telephone in his or her hand while jogging. Similarly, the speaker need not be inside the phone but can be in a separate headphone set worn around the ears.

When using headphones for cellular phones in this way, the microphone is usually placed adjacent the mouth and the headphone unit is placed in or around the ears. While placement of the microphone in front of the mouth may be perfectly suitable for many situations, such placement has certain drawbacks in other situations. One such drawback stems from the mere fact that the microphone is not concealed. For example, special operations or other soldiers on the battlefield may wish to be communicating with a commander or other soldiers without announcing to the enemy that that is what they are doing. Similarly, special operations or other soldiers on the battlefield have a strong need to be able to communicate even during explosions or other chaotic battle conditions, which damage equipment that stick out in front of the face.

Another drawback stems from the fact that using headphones in the traditional way requires transmitting sound vibrations from the mouth to a point outside the mouth where the microphone is located. Even though the microphone may be only a few centimeters from the mouth, the fact that the sound waves travel that distance outside the body leaves them open to noise interference from other points outside the body. For example, in a chaotic and noisy combat situation, the transmission to the microphone picks up all the noise around the soldier.

Another drawback is that placing the microphone in that location may obstruct visibility of the face of the user. That can be unseemly for reasons of appearances. For example, a priest or other religious preacher may need to speak to an audience and maintain a mood without appearing to be speaking into a bulky or unseemly contraption. This is only one example of a situation in which some people might not like the “look” of a microphone in front of the face. A totally different example is an actor or actress on stage may need to communicate to someone off stage without obstruction of the face. Obstructing visibility may also be annoying for the user when he or she looks downward.

There is therefore a need to have a microphone and headphone assembly wherein the entire assembly, other than limited components such as wires, is positioned in the ears of the user.

Another problem with prior art microphone and headphone assemblies is that when jogging or moving suddenly, the wearer experiences constant pulling pressure through the wire portions of the assembly against the units in or around the ear. Thus, the running motion or other up and down motion pulls the wires up and down and this in turn creates an uncomfortable pulling motion against the microphone unit and the headphone unit in the ear. In addition, the need to constantly reposition these units due to the pulling motion is a constant annoyance for the jogger or other wearer engaging in up and down movements.

It is practically an empirical fact that many joggers would appreciate being able to speak on their cellular telephone while running. There is therefore a need for a microphone and headphone assembly which can be worn during jogging and during other activity involving repeated up and down movements or sudden movements.

Another problem that occurs with the use of microphone and headphone assemblies is that different users require different sizes. Accordingly, there is a need to have such an assembly that is size-adjustable without incurring significant new manufacturing costs.

A further problem that occurs with the microphones is the phenomenon of noise or unwanted remnants of the sound vibrations other than those that enter the microphone. Various noise cancellation components have been taught in the prior art but they are complicated in that they use electrical components or they are not as effective as needed.

The present invention addresses the above problems, accomplishes all of the above objectives and offers still more.

### SUMMARY OF THE PRESENT INVENTION

The present invention provides a headphone and microphone assembly for a cellular telephone comprising a microphone unit, a headphone unit and a neck attachment unit. Both the microphone and headphone units go into the ear of the user, the microphone unit going into one ear and the headphone unit going into the other ear of the user. The microphone unit includes a microphone that has attached thereto a receiving element, such as an ear tube, that fits into a user's ear. The user's other ear takes the regular headphone unit. With the microphone in the ear the microphone picks up the sound of the user's voice by virtue of the fact that the sound of speech also reverberates through the head of the speaker. In this way the speaker's voice carries through his head to the receiving element. The microphone need not be placed in front of the mouth this way.

Because of the presence of the receiving element adjacent the microphone of the microphone unit and the speaker of the headphone unit, a first and second noise cancellation tube with special shape is added for eliminating dissonant sound. The noise cancellation tubes open to the open air.

The headphone unit is standard except that it is defined by a flexible adjustable member that goes around the ear of the user. In this manner the headphone unit can be fitted onto the ear of different people having different sized ears. In the prior art there is one size and the member that goes into the ear is rigid.

In addition, the device is held to a user around a neck of the user by a neck holding unit that alleviates the common problem of there being felt a pulling force against the headphones in the ears that typically occurs when the user wears the headphone in the ears while jogging (the pulling causes the wires to the headphones to jump up and down and pull against the headphones in the ears which is uncomfortable). The neck holding member has three points of attachment to further reduce this problem.

### Important Objects and Advantages

The following important objects and advantages of the present invention are:

(1) to provide a microphone and headphone assembly wherein the microphone unit is in a first ear of the user while the headphone unit is in the user's other ear;

(2) to provide a microphone and headphone assembly for use with cellular telephones wherein the microphone does not obstruct the front or side of the face at all;

(3) to provide such a microphone and headphone assembly wherein the microphone is not easily visible;

(4) to provide such an assembly that allows the user to wear the assembly comfortably during exercising such as jogging or gymnastics;

(5) to provide such an assembly that allows the user to wear the assembly when making sudden movements;

(6) to provide such an assembly that allows a user to wear the assembly without feeling a pulling motion against the headphone or microphone units in the ears;

(7) to provide such an assembly wherein the microphone unit has a noise cancellation system that is an open system;

(8) to provide such an assembly wherein in a preferred embodiment the noise cancellation system of the microphone unit and of the headphone unit are mechanical and require no additional electrical components;

(9) to provide such an assembly wherein the headphone unit has a noise cancellation system that is an open system;

(10) to provide such an assembly wherein in a preferred embodiment the noise cancellation system of the microphone unit and of the headphone unit are very effective in dissipating the unwanted noise;

(11) to provide such an assembly that uses a noise cancellation system including a first noise cancellation tube as part of the microphone unit and a second noise cancellation tube as part of the headphone unit;

(12) to provide an assembly as above wherein the earphone unit has an additional noise dissipating structure;

(13) to provide a microphone and headphone assembly which is adjustable to accommodate the height and size of the wearer;

(14) to provide a microphone and headphone assembly as described which is also lightweight;

(15) to provide a microphone and headphone assembly in which the microphone and headphone units are designed to be placed and maintained in or on the ears of the wearer yet dissonant noise from the wearer's body does not substantially interfere with operation of the assembly;

(16) to provide such an assembly wherein the microphone is concealed within the external ear canal of the user's ear and hence picks up sound vibrations directly from inside the body;

(17) to provide such an assembly wherein the microphone of the assembly does not pick up unwanted sound waves from outside the human body; and

(18) to provide such an assembly that can be concealed more effectively by allowing a wearer to reduce or eliminate unnecessary wire slack which would otherwise protrude, for example by means of a slack adjustment element or elements.

### BRIEF DESCRIPTION OF THE DRAWINGS

FIG. 1 is a top plan view of the complete assembly of the present invention;

FIG. 2a is a top plan view of the first noise cancellation tube of the microphone unit of the assembly of the present invention;

FIG. 2b is a vertical cross-section view of FIG. 2a;

FIG. 2c is a horizontal cross-sectional view of FIG. 2a taken along line 2c-2c running through the muffler;

FIG. 2d is a horizontal cross-sectional view of FIG. 2a taken along line 2d-2d running through the muffler;

FIG. 2e is an enlarged fragmentary vertical cross-sectional view of FIG. 2a showing the flow of noise vibrations;

FIG. 3a is a side view of the visible portions of the microphone unit and holder unit of the assembly of the present invention placed in the user's ear;

FIG. 3b is an enlarged fragmentary partial sectional view of the holder unit on a user showing the clothing of the user in section;

FIG. 4 is an enlarged fragmentary vertical cross-sectional view of the second noise cancellation tube of the headphone unit of the assembly of the present invention;

FIG. 5 is a partial sectional view of the microphone unit of the assembly of the present invention connected to the inside of the ear and with only the first wire of the microphone unit not presented in section;

FIG. 6a is a partial sectional view of the microphone unit of the assembly of the present invention with only the first wire of the microphone unit not presented in section;

FIG. 6b is a side perspective view of the cap of the microphone unit;

FIG. 6c is a rear view of the cap of FIG. 6b;

FIG. 6d is a front view of the cap of FIG. 6b;

FIG. 7 is a partial sectional view of the headphone unit of the assembly of the present invention connected to the inside of the ear and with only the second wire of the headphone unit not presented in section;

FIG. 8a is a partial sectional view of the headphone unit of the assembly of the present invention with only the second wire of the headphone unit not presented in section;

FIG. 8b is a side perspective view of the cap of the microphone unit;

FIG. 8c is a rear view of the cap of FIG. 8b; and

FIG. 8d is a front view of the cap of FIG. 8b.

### DETAILED DESCRIPTION OF THE PREFERRED EMBODIMENT

The apparatus of the present invention will now be illustrated by reference to the accompanying drawings. The assembly of the present invention has been assigned reference numeral 10 Other elements of the assembly have been assigned the reference numerals referred to below.

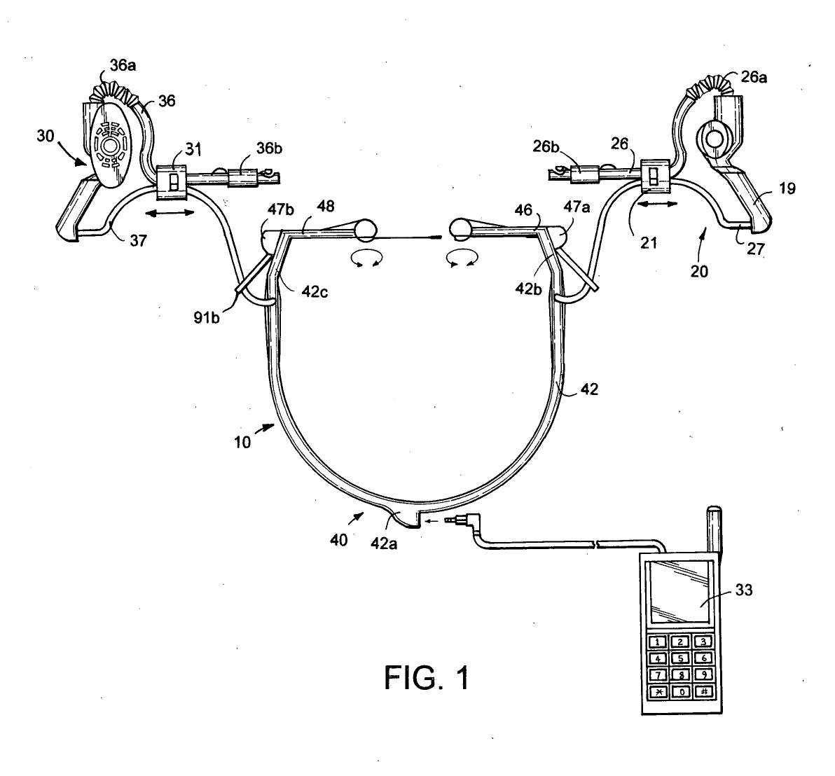

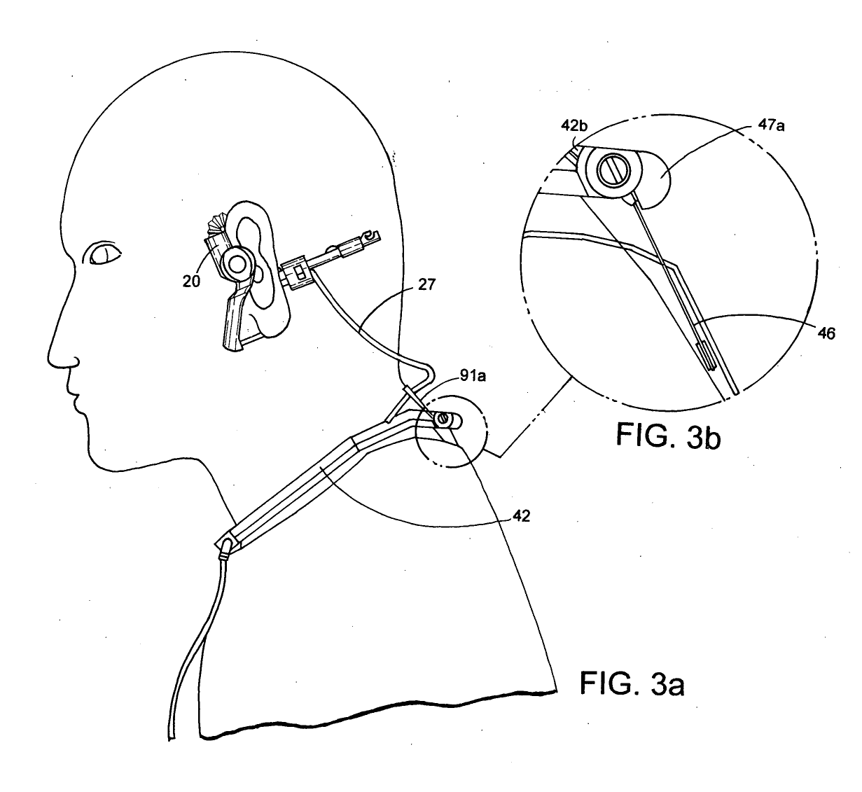

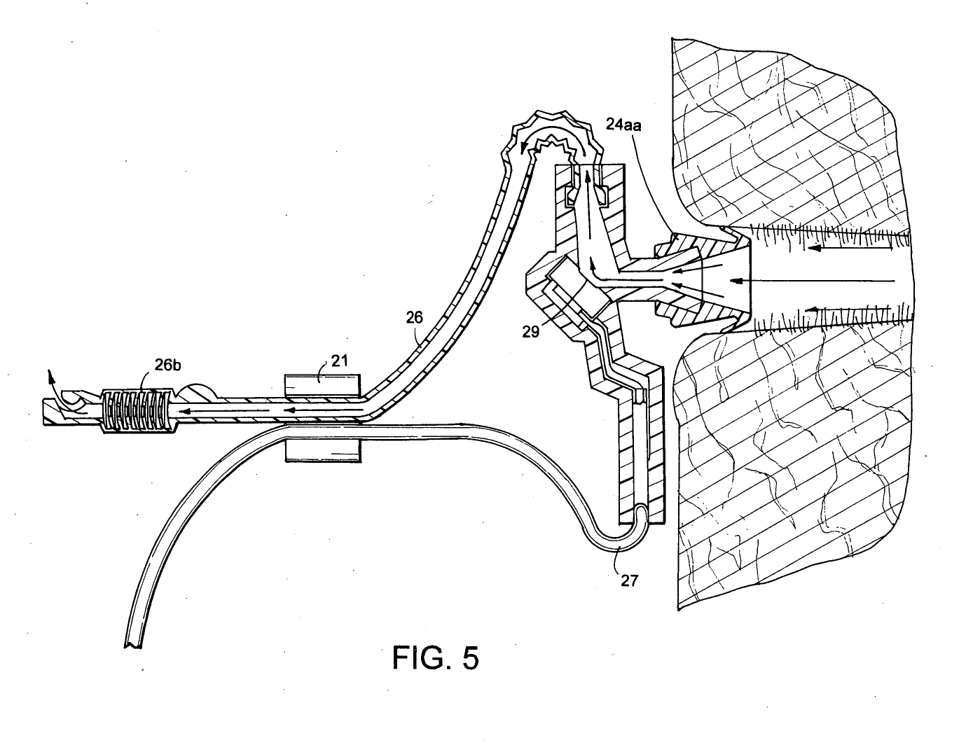

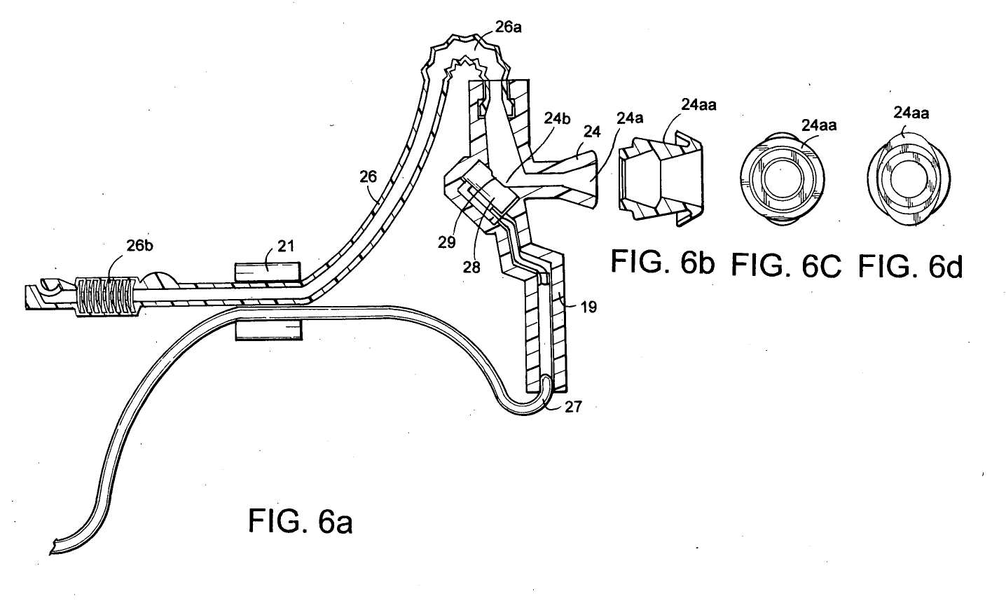

As seen from FIGS. 1-8c, the present invention is a headphone and microphone assembly 10, also called an earphone and microphone assembly, and is designed to plug into a communication device such as a cellular telephone. The assembly 10 overall comprises a microphone unit 20, a headphone unit 30 and a neck attachment unit 40, the latter also referred to as a holder unit 40. As will be appreciated, microphone unit 20 comprises an open system whereas headphone unit comprises both an open system and a closed system.

Microphone unit 20 is designed to fit into and be placed into a first ear of a user. This does not mean necessarily that the entire microphone unit 20 fits inside the ear of the user but rather that at least a portion is designed to fit into the ear of the wearer/user. Typically, it is the external ear canal of the user's ear that would receive the microphone unit 20. In a preferred embodiment, the entire microphone unit 20 other than the wires are placed and maintained in and around the ear of the wearer.

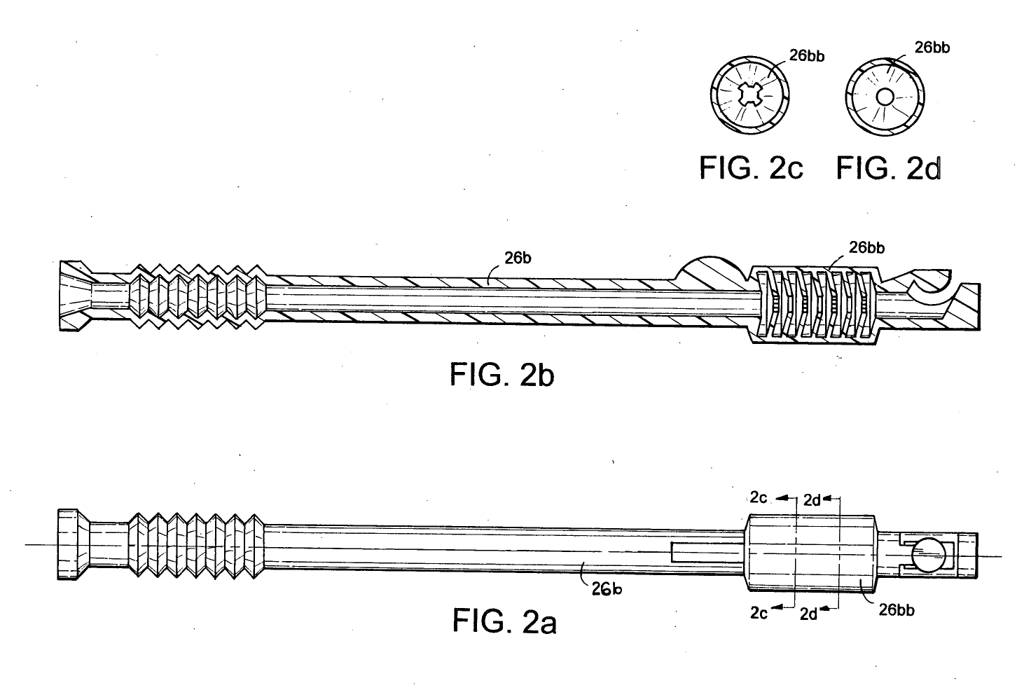

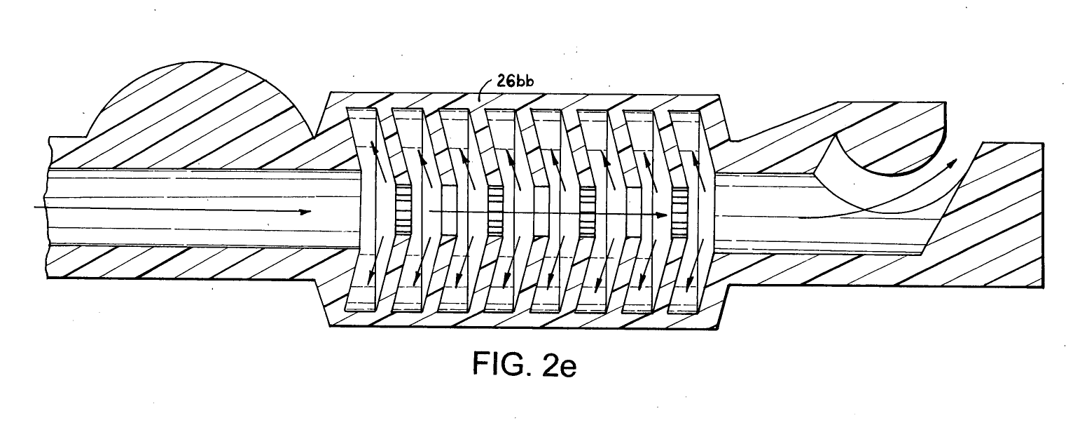

The microphone unit 20 includes a receiving element such as an ear tube 24, a first noise cancellation tube 26 (that contains a first part 26a and a second part 26b), a microphone 28 and a wire cover piece 19 for the first wire 27 that leaves the microphone 28 of microphone unit 20. In a preferred embodiment, the microphone 28 includes standard elements known by those skilled in the art including a diaphragm 29. The ear tube 24 has a first end 24a for receiving vibrations from the user's body and a second end 24b proximate to the diaphragm 29. As best seen in FIG. 2b, ear tube 24 of microphone unit 20 is positioned so that sound vibrations transmitted by the ear tube 24 to microphone 28 strike the sensor 29 of microphone 28 at approximately a 45 degree angle. In one preferred embodiment, the sensor 29 of microphone 28 may be a simple diaphragm.

Since the purpose of microphone unit 20 is to collect sound from the human voice microphone cap fits snugly into the first ear and microphone cap flanges cover any gap between the ear and the microphone cap. It is also noted that microphone 28 of microphone unit 20 is positioned away from the external ear wall of the first ear to ensure that microphone 28 does not collect all the sounds from the human body, but rather only those sound that are from the wearer's voice. Thus breathing and teeth chattering are excluded since these sounds are too low.

Ear tube 24 of microphone unit 20 also has an ear tube cap 24aa for fitting ear tube 24 into the first ear of the user and for concentrating the sound from the body to the microphone. The ear tube cap 24aa is not limited to the exact shape illustrated in the drawings but can be any shape suitable for securely fitting ear tube 24 into the first ear and concentrating the sound traveling into the microphone.

First part 26a of first noise cancellation tube 26 of microphone unit 20 extends from the microphone 28 and the other end of first noise cancellation tube 26 extends out to the open air. The primary purpose of first noise cancellation tube 26, and that of second noise cancellation tube 36 of headphone unit 30 which is discussed below, is to dissipate noise that from outside the body of the wearer of assembly 10. It is believed in general that this is more important than unwanted noise vibrations emanating from inside the body of the wearer since such sound from inside is likely to be transferable to outside the body through the assembly 10 without as much unwanted reverberations.

In one preferred embodiment, the proximal end of the first part 26a of first noise cancellation tube 26 is positioned so that it is at approximately a normal angle to the ear tube 24 and approximately at a 45 degree angle to the diaphragm 29. In this way, first noise cancellation tube 26, which in a one preferred embodiment is also at approximately a 45 degree angle to the diaphragm 29, is best able to receive the noise remnant of the sound vibrations that travel from the ear tube 24 to the microphone 28. This preferred embodiment allows sufficient room for first part 26a of first noise cancellation tube 26 to be positioned without interfering with ear tube 24.

FIG. 2e is an enlarged fragmentary vertical cross-sectional view of second part 26b of first noise cancellation tube 26 shown in FIG. 2a. The arrows in FIG. 2e represent air flow and FIG. 2e shows the flow of noise vibrations from inside the body of the user to the outside. There is a hole in the center of the second part 26b of first noise cancellation tube 26 for the main flow of air carrying sound vibrations. Muffler 26bb of second part 26b of first noise cancellation tune 26 dissipates the noise when air flows to the left and right of the hole as it passes through first noise cancellation tube 26. Similarly, muffler 36bb of second part 36b of first noise cancellation tune 36 dissipates the noise when air flows to the left and right of the hole as it passes through second noise cancellation tube 36.

In addition to first noise cancellation tube 26, microphone unit 20 also has the additional noise dissipation structures described below.

Generally, sensor 29 or diaphragm 29 of microphone 28 need not be at a 45 degree angle to the directions of incoming sound vibrations or to the direction of outgoing noise going to the first part 26a of first noise cancellation tube 26. Rather sensor 29 need only be positioned such that the sound vibrations traveling through ear tube 24 strike sensor 29 at a first angle f and the first part 26a of first noise cancellation tube 26 is positioned so that the proximal end of the first part 26a of first noise cancellation tube 26 is at a second angle s relative to sensor 29 or diaphragm 29 of microphone 28.

The microphone 28 is connected by a first wire 27 to a communication device such as a cellular telephone 33. The microphone unit 20 also includes a first movable joint 21 for holding the first wire 27 and the first noise cancellation tube 26. This allows first movable joint 21 to function as a slack adjustment element for controlling the length of slack of the first wire 27. As a result of first movable joint (and as a result of second movable joint 31, as discussed below), assembly 10 can be concealed more effectively by allowing the wearer to reduce or eliminate unnecessary wire slack that would otherwise protrude, for example, beyond a shirt collar or other clothing.

An integral part of assembly 10 is headphone unit 30, which fits into a second ear of the user. In this way, the entire assembly 10 fits into the two ears of the user except for the neck attachment unit 40 and associated wires and even these parts are not readily visible when the user is clothed with a shirt. Headphone unit 30 includes an earphone cap 39 and a speaker 130. Generally, headphone unit 30 taken alone is generally standard and known to those skilled in the art, except that headphone unit 30 has a second noise cancellation tube 36 and except as described below. The speaker 130 of headphone unit 30 is connected to a communication device such as a cellular telephone by a second wire 37. Headphone unit 30 includes a second movable joint 31 for holding the second wire 37 and second noise cancellation tube 36 and for controlling the length of the slack of the second wire 37.

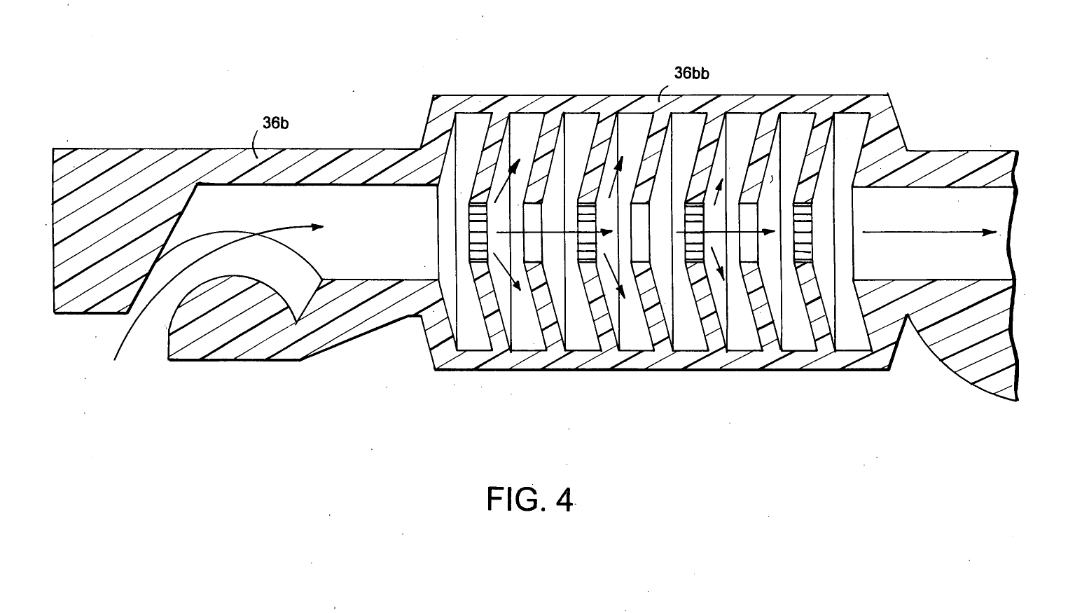

FIG. 4 is an enlarged fragmentary vertical cross-sectional view of the second part 36b of second noise cancellation tube 36 of the headphone unit 30 of the assembly of the present invention. The arrows show air flow and FIG. 4 is designed to depict the air flow in the direction from outside the body to inside the body because external sound is likely to be louder. The second part 36b of noise cancellation tube 36 of the headphone unit 30 is designed to dissipate noise coming from outside the body of the wearer, for example battlefield explosions if the wearer is a soldier, as well as to dissipate noise coming from the speaker 130. Thus a soldier on the battlefield who wears the assembly of the present invention can be mostly prevented from having to hear the explosions around him.

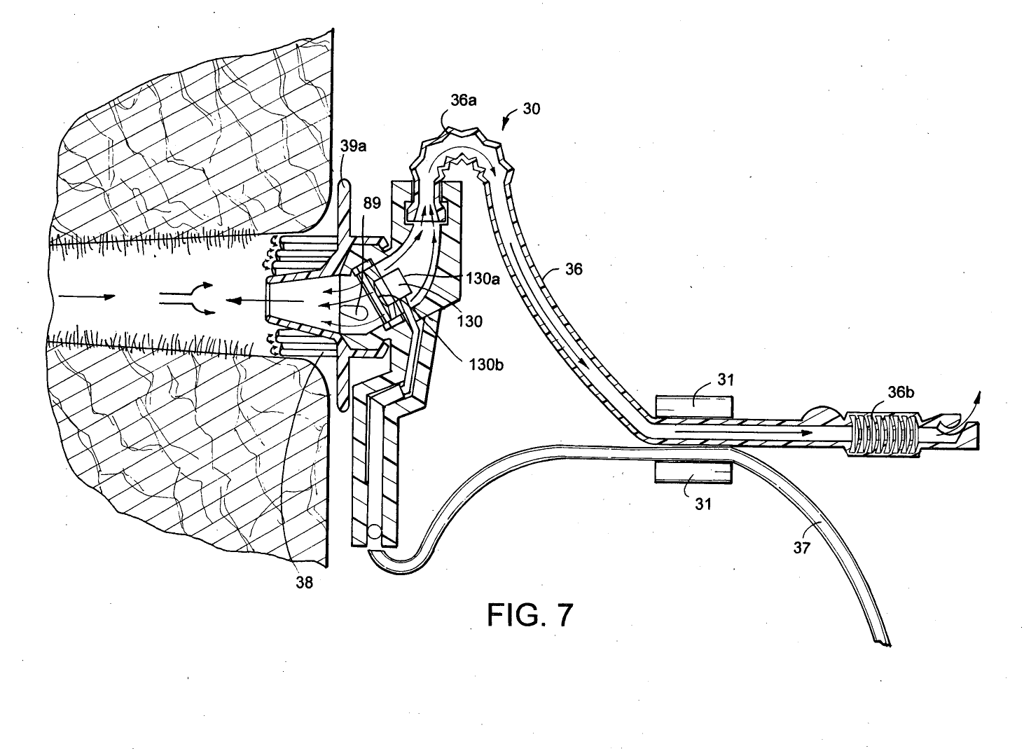

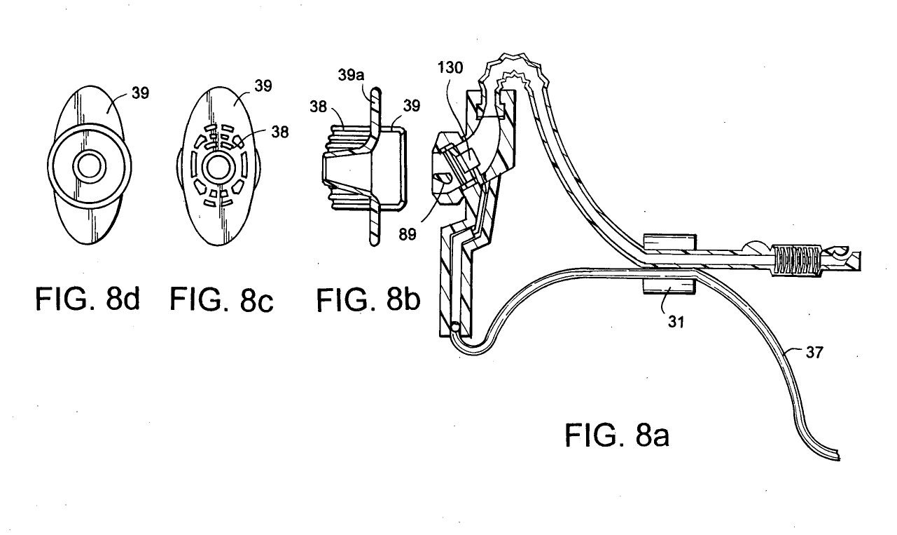

As seen from FIG. 7, headphone unit 30 also contains a column element 89 to concentrate the flow of air into the center of the ear bearing the headphone unit 30. It is desirable if air flow at both the front and the rear of the speaker 130 move freely during the time the speaker 130 is in operation. As seen in FIG. 7 and FIG. 8a, instead of speaker 130 being positioned so that its rear facade is essentially parallel to the direction of the second noise cancellation tube 36, in the present invention the speaker 130 is slightly rotated so that rear facade 130a of speaker 130 faces the direction of air flow through second noise cancellation tube 36. This improves the connection of air flow traveling into second noise cancellation tube 36. As a result, however, the air flow at the front of speaker 130 is not in its natural position with its front facade 130b facing the direction of air flow into the ear canal.

Hence, a small piece or column element 89 is added in front of the speaker 130 to concentrate the flow of air out the earphone cap in a more natural manner. As a result of Bernoulli's principle, the length on the side of the speaker 130 nearer column element 89 exceeds the length on the other side of speaker 130 and therefore upside air flow is faster than downside air flow creating a partial vacuum near column element 89. The existence of column element 89 thus changes the direction of downside airflow upward somewhat and this concentrates air flow to the center of the earphone car to leave the ear of the user more easily.

The third part of assembly 10 is a neck attachment unit 40 or holder unit 40 which allows the entire assembly 10 to be worn comfortably around the neck of the user. Neck attachment unit 40 comprises a substantially C-shaped holder 42 that holds the first wire 27 and the second wire 37. C-shaped holder 42 is shaped to surround the neck of a user other than the back of the user's neck.

In a preferred embodiment, first wire 27 and second wire 37 enter opposing sides of the holder 42 and exit the holder 42 at the central portion 42a of holder 42. In an alternative embodiment, the first wire 27 and second wire 37 exit holder 42 not at central portion 42a but at a more remote portion of holder 42.

The first end 42b of the C-shaped holder 42 is joined to a first swivel arm 46 that grips the user, the user's clothing or an accessory attached to the user or the user's clothing. Similarly, the second end 42c of the C-shaped holder 42 is joined to a second swivel arm 48 that still further grips the user, the user's clothing or an accessory attached to the user or to the user's clothing. In a preferred embodiment, the first and second swivel arms 46, 48 are capable of swinging outside a two-dimensional plane of the holder 42 to specifically extend between the user's back and the user's clothing (or between different layers of the user's clothing) and thereby being held or stuck between the back and the clothing (or between different layers of the clothing). First swivel arm 46 pivots on third movable joint 47a of holder 42 which joint 47a acts as a fulcrum and second swivel arm 48 pivots on fourth movable joint 47b of holder 42 which joint 47b acts as a fulcrum.

A central portion 42c of C-shaped holder 42 is held in place by the natural curvature of the front of user's neck. Furthermore, it should be noted that first and second swivel arms 46, 48 can be held in place even if the user is a male and wears no clothing above his waist (he takes off his shirt during jogging for example) since the swivel arms 46, 48 are manually rotated by the wearer to extend to a point alongside the back of the wearer and thereby grip the wearer's back at two points. Furthermore, the sides of the C-shaped holder 42 grip the sides of the wearer's neck.

Adjacent third movable joint 47a and adjacent fourth movable joint 47b are rubber bands 91a, 91b that hold the ends of the first wire 27 and second wire 37 so as to control the actual length of the electric lines (i.e. first and second wires 27, 37). First and second wires 27, 37 run through rubber bands 91a, 91b without secure attachment. Hence, when the user wearing assembly 10 wants to turn or move his or her neck one or more of the rubber bands 91a, 91b stretch the user feels a slight strain from the resistance of the rubber bands

In a preferred embodiment, the first part 26a of the first noise cancellation tube 26 and the first part 36a of the second noise cancellation tube 36 (or at least first part 26a of first noise cancellation tube 36 or first part 36a of second noise cancellation tubes 26) have an accordion-like cross-section at various portions of the length of first and second noise cancellation tubes 26, 36. In the areas of first and second noise cancellation tubes 26, 36 where the cross-sections are accordion-like, the cross-sections have alternating larger and smaller sections of thickness of the tube, as seen in FIGS. 1, 5, 7. The sound waves entering first noise cancellation tube 26 or second noise cancellation tube 36 keep hitting the walls of said first parts 26a, 36a of said tubes 26, 36 and thereby continuously lose energy. In this way, the accordion-like shape of the cross-section of first parts 26a, 36a of first and second noise cancellation tubes 26, 36 serve to dissipate the sound waves of the unwanted sound vibrations that constitute noise.

In addition to first and second noise cancellation tubes 26, 36, assembly 10 has other noise dissipation structures. For example, as part of earphone unit 30, and as best seen in FIGS. 7, 8b and 8c, ear phone cap 39 of earphone unit 30 has a series of elongated prongs or columns 38 that physically divide the cross-sectional space inside ear phone cap 39. As best seen in FIGS. 8c and 8d, elongated prongs 38 dissipate sound vibrations that enter the external ear canal of the second ear from the speaker, bounce off the eardrum and travel back toward the speaker of earphone unit 30 opposite the direction of the sound vibrations emanating from the speaker of earphone unit 30. Without elongated prongs 38, the sound vibrations bouncing off the eardrum would approach the speaker and effectively counteract the sound vibrations traveling from the speaker of earphone unit 30 to the ear drum of the second ear (the ear having the earphone unit 30) of the wearer.

Although in a preferred embodiment, elongated prongs 38 are substantially parallel to one another to best ensure that prongs 38 accomplish their purpose without obstructing the sound vibrations waves from speaker, in other preferred embodiments, the elongated prongs 38 are not substantially parallel.

As a result of prongs 38 there would be a gap between cap 39 and the ear of the wearer if not for the presence of cap flange 39a which operates to block external noise from entering the ear.

Earphone cap 39 is to attach headphone to second ear and to dissipate unwanted noise, as explained. Thus the shape of earphone cap 39 is not limited to the exact shape illustrated in the drawings bit can be any shape suitable for its purpose.

As can be seen from the above description, the present invention allows someone to be active and speak on the cellular telephone at the same time without having to hold or position a microphone in front of the mouth or in a visible position.

It is to be understood that while the apparatus of this invention have been described and illustrated in detail, the above-described embodiments are simply illustrative of the principles of the invention. It is to be understood also that various other modifications and changes may be devised by those skilled in the art which will embody the principles of the invention and fall within the spirit and scope thereof. It is not desired to limit the invention to the exact construction and operation shown and described. The spirit and scope of this invention are limited only by the spirit and scope of the following claims.

What is claimed is:

1. A headphone and microphone assembly for a cellular telephone comprising:
(i) a microphone unit that fits into a first ear of a user, the microphone unit including an ear tube, a first noise cancellation tube and a microphone that has a sensor,
the ear tube having a first end for receiving vibrations from the user's body and a second end proximate to the sensor and positioned so that sound vibrations from the ear tube strike the sensor at a first angle, the first noise cancellation tube extending from the microphone to an open air, a proximal end of the first noise cancellation tube being at a cumulative angle to the ear tube and positioned at a second angle to the sensor to receive a noise remnant of the sound vibrations, the microphone connected by a first wire to a communication device,
the microphone unit including a first movable joint for holding the first wire and the first noise cancellation tube and for controlling a length of slack of the first wire, and
(ii) a headphone unit that fits into a second ear of the user, the headphone unit including an earphone cap and a speaker and having a second noise cancellation tube, the speaker connected to a communication device by a second wire, the headphone unit including a second movable joint for holding the second wire and second noise cancellation tube and for controlling a length of slack of the second wire, and
(iii) a neck attachment unit for wearing the assembly around the neck of the user and comprising a substantially C-shaped holder that holds the first wire and the second wire, the first and second wires entering opposing sides of the holder and exiting the holder at the central portion thereof, a first end of the C-shaped holder joined to a first swivel arm that further grips the user, and a second end of the C-shaped holder joined to a second swivel arm that further grips the user.

2. The assembly of claim 1, wherein at least one of the first and second noise cancellation tubes has an accordion-like cross-section with alternating larger and smaller sections of the tube.

3. The assembly of claim 1, wherein the ear tube has a series of elongated prongs to divide and reduce dissonant sound waves.

4. The assembly of claim 3, wherein the elongated prongs are substantially parallel to one another.

5. The assembly of claim 1, wherein at least one of the first and second noise cancellation tubes has an accordion-like cross-section with alternating larger and smaller sections of the tube and wherein the ear tube has a series of elongated prongs to divide and reduce dissonant sound waves.

6. The assembly of claim 1, wherein the first and second swivel arms are capable of swiveling outside a two-dimensional plane of the holder to extend between the user's back and clothing.

7. The assembly of claim 1, wherein the first angle and the second angle are each approximately 45 degrees and wherein the cumulative angle is approximately 90 degrees.

8. The assembly of claim 1, wherein the first end of the ear tube of the microphone unit is designed to be positioned against an ear wall of the first ear.

9. The assembly of claim 2, wherein the first and second swivel arms are capable of swiveling outside a two-dimensional plane of the holder to extend between the user's back and clothing.

10. The assembly of claim 1, wherein the ear tube includes an ear tube cap for fitting the ear tube into the first ear.
